(19) United States
(12) Patent Application Publication
(10) Pub. No.: US 2011/0139815 A1
(43) Pub. Date: Jun. 16, 2011

(54) Self-Righting Dispenser

(76) Inventor: Keith Benson, Hutto, TX (US)

(21) Appl. No.: 13/058,309

(22) PCT Filed: Jun. 29, 2009
(86) PCT No.: PCT/US2009/049054

§ 371 Date: Feb. 9, 2011

Related U.S. Application Data
(60) Provisional application No. 61/101,783, filed on Oct. 1, 2008.

(51) Int. Cl. B65D 25/52; B65D 41/04; B67D 3/02; B23P 11/00

(52) U.S. Cl. 222/1; 222/463; 220/288; 222/526; 29/428

(57) ABSTRACT

A dispenser includes a self-righting housing having an interior cavity for holding one or more items to be dispensed, a curved bottom surface, and a dispensing aperture disposed in a lower portion of the housing and in communication with the interior cavity.

### PRIORITY CLAIM

The present application hereby claims benefit of priority under 35 U.S.C. §365 to the previously filed international patent application number PCT/US2009/049054 entitled, “Self-Righting Dispenser,” filed on Jun. 29, 2009, naming Keith Benson as sole inventor and having a priority date of Oct. 1, 2008, based upon U.S. Provisional Patent Application No. 61/101,738. Both applications are herein incorporated by reference in their entirety and for all purposes.

### BACKGROUND OF THE INVENTION

1. Technical Field

The present invention relates in general to a self-righting dispenser of items, for example, animal food and/or animal treats.

2. Description of the Related Art

Various types of dispensers are known in the art. A common objective of many conventional animal treat dispensers is to use the dispensing of treats to incentive animal interaction with the animal treat dispenser. One such animal treat dispenser is disclosed in U.S. Pat. No. 6,526,912 to Ottoson.

### SUMMARY OF THE INVENTION

In at least one embodiment, a dispenser includes a self-righting housing having an interior cavity for holding one or more items to be dispensed, a curved bottom surface, and a dispensing aperture disposed in a lower portion of the housing and in communication with the interior cavity.

### BRIEF DESCRIPTION OF THE DRAWINGS

The present invention, as well as a preferred mode of use, will best be understood by reference to the following detailed description of one or more illustrative embodiments when read in conjunction with the accompanying drawings, wherein:

FIG. 1 is a front view of a dispenser in accordance with one embodiment;

FIG. 2 is another front view of the dispenser of FIG. 1 depicted with the cap removed;

FIG. 3 is a bottom plan view of the dispenser of FIG. 1;

FIG. 4 is a view of a dispenser of FIG. 1 illustrated with the cap removed;

FIG. 5 is more detailed front view of the dispenser of FIG. 1 depicting the lower aperture in a closed state;

FIG. 6 is a detailed front view of the dispenser of FIG. 1 with the lower housing depicted in phantom;

FIG. 7 is a top plan view of the interior of the lower housing of the dispenser of FIG. 1;

FIG. 8 is a top plan view of the interior of the lower housing of the dispenser of FIG. 1 with the base plate removed;

FIG. 9 is a top plan view of the interior of the lower housing of the dispenser of FIG. 1 with the base plate and weight removed; and

FIG. 10 is a view of the interior of the upper housing of the dispenser of FIG. 1.

### DETAILED DESCRIPTION OF ILLUSTRATIVE EMBODIMENT

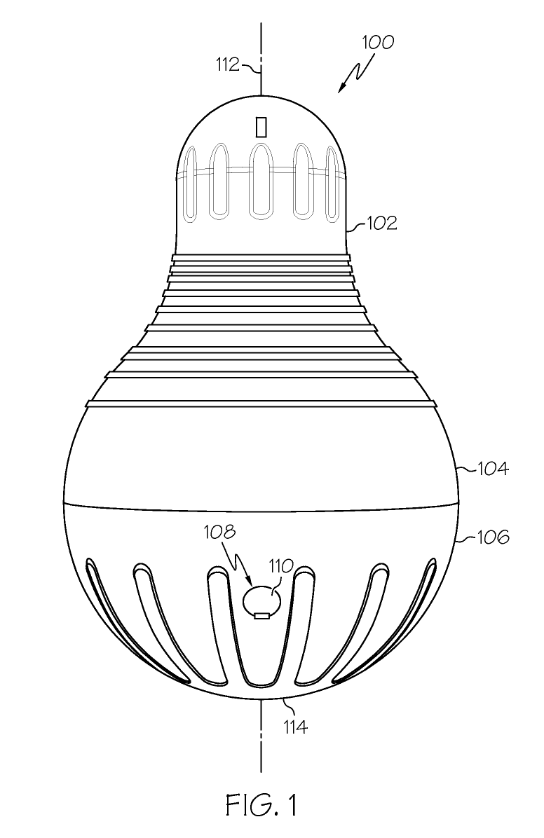

With reference now to the figures and with particular reference to FIG. 1, there is illustrated a front view of an exemplary dispenser 100 in accordance with one embodiment. In the following description, various relative terms such as upper, lower, etc. will be employed to describe dispenser 100. It should be understood that all such terms are utilized for ease of description assuming the orientation of dispenser 100 depicted in FIG. 1 and are not to be construed as limiting the application of the claimed invention to dispensers in different orientations or described utilizing other terminology. Further, although dispenser 100 is suitable for dispensing animal treats and/or animal food, it will be appreciated that the disclosed dispenser is not limited in application to animal treats or animal food and is also suitable for dispensing other items, if desired.

Dispenser 100 can have any desired size, which can be influenced by any number of factors, such as the size of items (e.g., animal treats or food) to be dispensed, the intended application of dispenser 100 (e.g., the type, breed and/or size of animal that will interact with dispenser 100), cost of manufacture, consumer preferences, etc. Dispenser 100 is preferably manufactured from one or more durable materials, such as one or more plastics. If one or more plastics are utilized, the components of dispenser 100 described below can be molded utilizing known techniques.

Dispenser 100 has a self-righting housing, which in the embodiment of FIG. 1 is generally teardrop shaped. In the depicted exemplary embodiment, the self-righting housing of dispenser 100 is generally radially symmetrical about central vertical axis 112 and comprises a cap 102, an upper housing 104 and a lower housing 106.

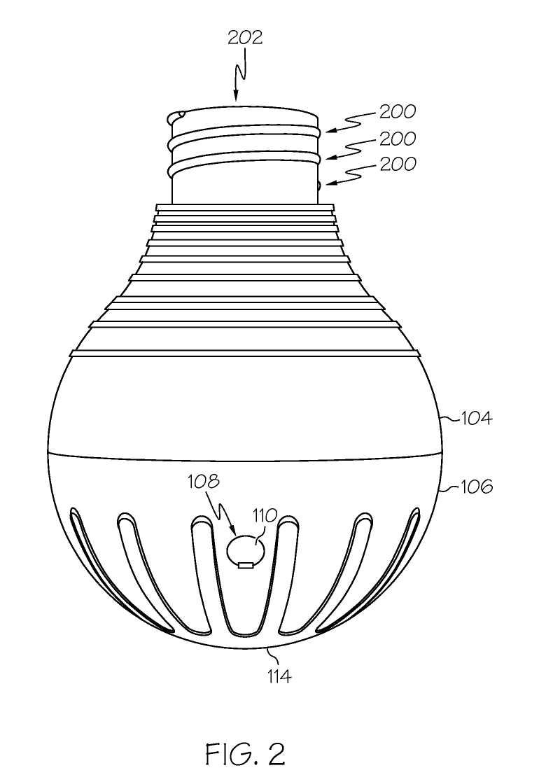

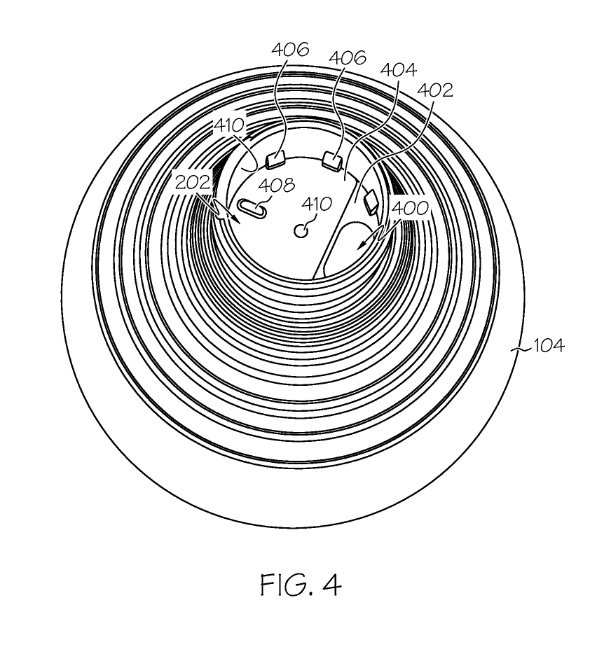

In at least some embodiments, cap 102 can be removably coupled and recoupled to upper housing 104 to permit items to be inserted into an upper cavity 202 (see, e.g., FIGS. 2 and 4) formed in upper housing 104. For example, in the embodiment depicted in FIG. 2, cap 102 can be coupled to upper housing 104 by threads 200 formed on an outer surface upper housing 104 and corresponding threads or ridges formed on an inner surface of cap 102. Of course, in other embodiments, the thread arrangement of cap 102 and upper housing 104 can be varied, for example, with threads external to cap 102 and corresponding features formed on an inner surface of upper cavity 202. Further, the coupling between cap 102 and upper housing 104 is not required to be threaded, and any other reasonably secure coupling that permits the coupling, decoupling, and recoupling of cap 102 and upper housing 104 is contemplated.

Upper housing 104 and lower housing 106 can be made as a unitary piece, but for ease of manufacture are preferably separately made and then attached to each other, for example, by interlocking threads, adhesive, sonic welding, press fitting, and/or other known technique. The attachment can be made easily reversible by the human consumer (as in the case of interlocking threads), for example, for ease of cleaning or storage, or alternatively, can be made effectively irreversible (as in the case of adhesive attachment, sonic welding or press fitting).

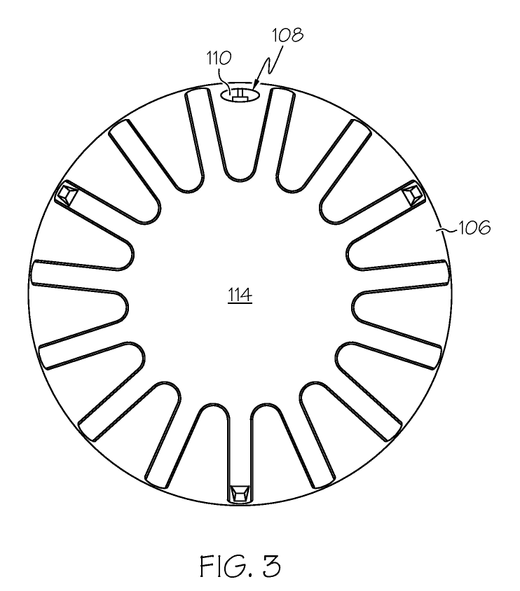

As shown in FIGS. 1-3, lower housing 106 of dispenser 100 preferably has a curved or arcuate bottom 114 that is intended to rest on an underlying surface, such as the ground or a floor. Lower housing 106 preferably contains or has a sufficient weight (discussed further herein), which together with curved bottom 114, permits dispenser 100 to self-right when disturbed from the upright orientation depicted in FIG. 1. The outer surface of some or all of lower housing 106 may optionally be textured by a surface finish of the material utilized for lower housing 106 or by an applied coating to increase its coefficient of friction and reduce a tendency of dispenser 100 to slide rather than tip when horizontal force is imparted to dispenser 100.

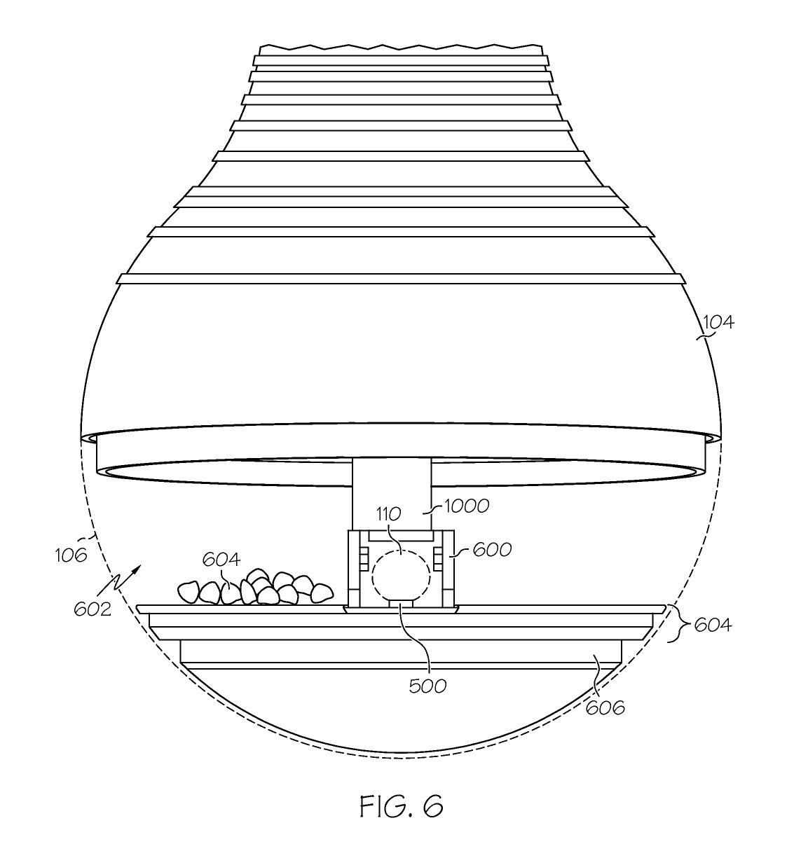

Referring now to FIG. 4, there is depicted a view of dispenser 100 with cap 102 removed. As noted above, upper housing 104 has an upper cavity 202 for holding items to be dispensed. Items to be dispensed, such as animal treats, are introduced into upper cavity 202, for example, by removing cap 102 and placing or pouring the items into upper cavity 202. In a typical use scenario, cap 202 is then recoupled to top housing 104 to prevent the items from spilling from upper cavity 202 directly to an exterior of dispenser 100. Upper cavity 202 has a floor 402 having an upper aperture 400 through which items may pass to reach a lower cavity 602 of dispenser 100 (described with reference to FIG. 6 below).

The effective size of upper aperture 400 is preferably adjustable to permit a user to control the flow of items from upper cavity 202 to the lower cavity. In the illustrated embodiment, the effective size of upper aperture 400 can be adjusted by a rotatable plate 404 captured between a floor 402 of upper cavity 202 and tabs 406 extending from inner sidewall 410 of upper cavity 202. Rotatable plate 404 is manually rotatable about a boss 410 on floor 402 extending into a concavity or hole in rotatable plate 404, and manual rotation of rotatable plate 404 is facilitated by an upwardly extending tab 408. Thus, by applying manual force to tab 408 with a finger, a person can rotate rotatable plate 404 until upper aperture 400 is fully exposed, partially exposed, or completely blocked by rotatable plate 404. Rotatable plate 404 is retained in the selected position, for example, by friction between the upper surface of rotatable plate 404 and the bottom of tabs 406, until the position of rotatable plate 404 is subsequently readjusted. Of course in other embodiments, one or more other adjustment mechanisms, such as a sliding door or partial plug that partially fills upper aperture 400, can be used to adjust the effective size of upper aperture 400.

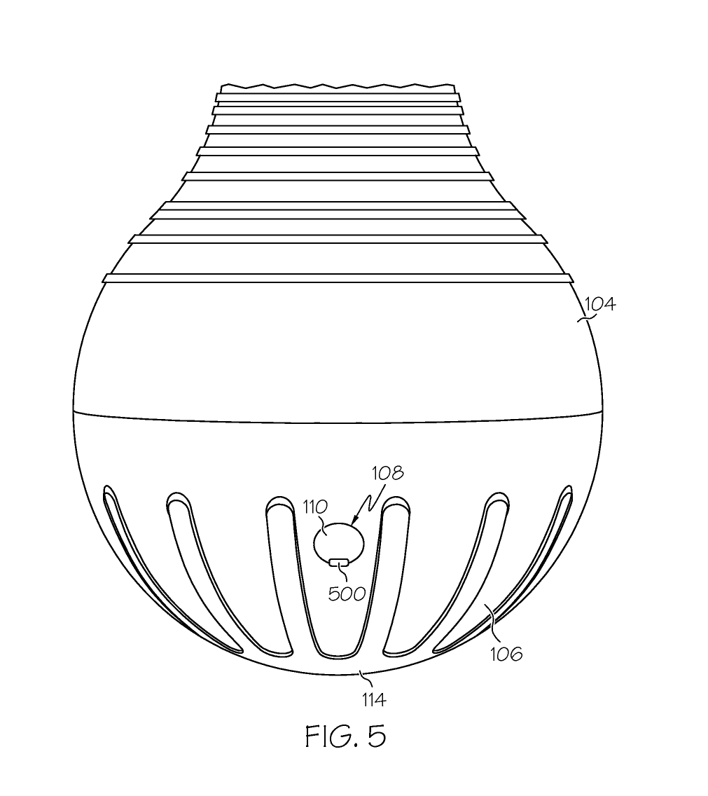

With reference now to FIGS. 5-6, more detailed views of lower housing 106 of dispenser 100 and its contents are illustrated. In particular, FIG. 5 is a front elevation view of lower housing 106, and FIG. 6 is a second front elevation view in which lower housing 106 is illustrated in phantom.

FIGS. 5-6 depict lower housing 106 of dispenser 100 having a lower aperture 108 through which items 604 (e.g., animal treats) may be dispensed from a lower cavity 602 within dispenser 100 to an exterior of dispenser 100. In various embodiments, lower cavity 602 may include some or substantially all of the volumes of upper housing 104 and lower housing 106. Further, although in the illustrated embodiment items to be dispensed pass directly from upper cavity 202 into lower cavity 602, in other embodiments one or more additional chambers or passages may be disposed between upper cavity 202 and lower cavity 602, for example, to regulate the rate of dispensing of items 604 via lower aperture 108.

In a preferred embodiment, the effective size of lower aperture 108 is adjustable to permit a human to control the dispensing of items from lower cavity 602. In the illustrated embodiment, the effective size of lower aperture 602 can be adjusted by a sliding door 110 captured in a frame 600 disposed adjacent lower aperture 602. Manual manipulation of sliding door 110 is facilitated by an outwardly extending tab 500. Thus, by applying manual force to tab 500 with a finger, a person can translate sliding door 110 until lower aperture 108 is fully open, partially open, or completely blocked by sliding door 110 (as shown in FIG. 6). Sliding door 110 is retained in the selected position, for example, by friction between sliding door 110 and frame 600, until subsequently adjusted. Of course in other embodiments, one or more other adjustment mechanisms, such as a rotating plate or partial plug, can be used to adjust the effective size of lower aperture 108.

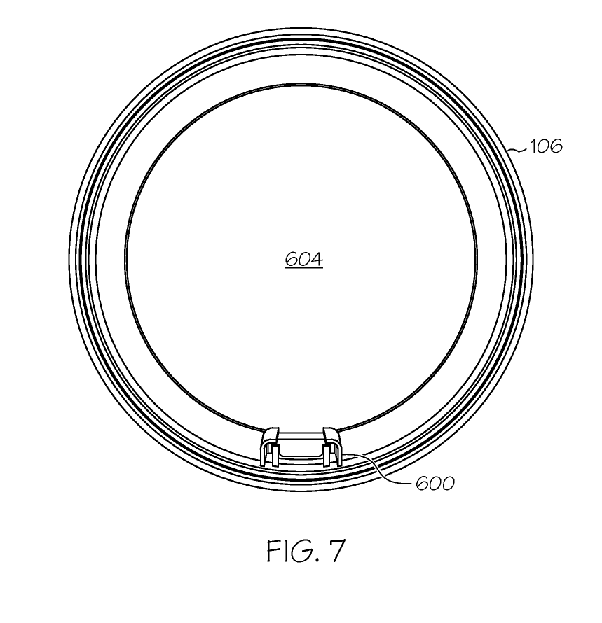

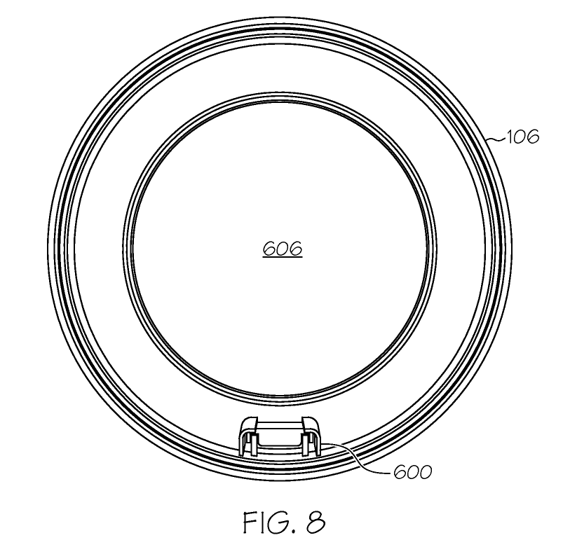

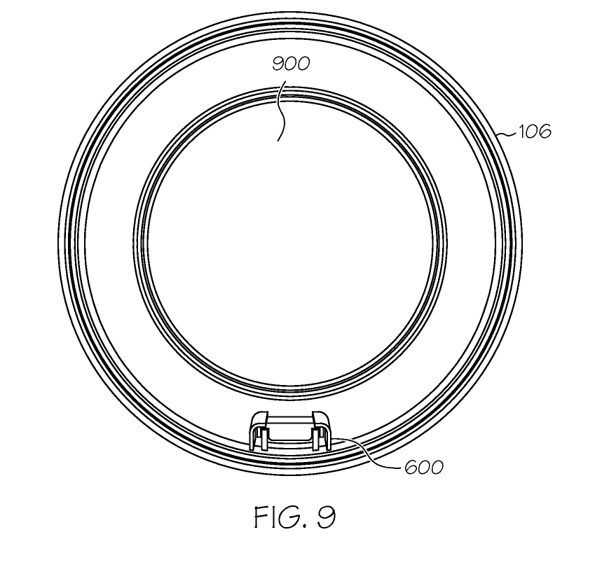

FIGS. 6-9 further illustrate that in the depicted exemplary embodiment, lower housing 106 of dispenser 100 contains a base plate 604 defining an extent of lower cavity 602. Base plate 604 rests on a weight 606 that, given curved bottom 114 of lower housing 104, causes dispenser 100 to self-right if tipped. Weight 606 and/or base plate 604 is/are preferably secured to interior surface 900 of lower housing 106. A separate weight 606 can be omitted in embodiments in which lower housing 106 and/or items 604 within lower cavity 602 has sufficient mass to self-right dispenser 100.

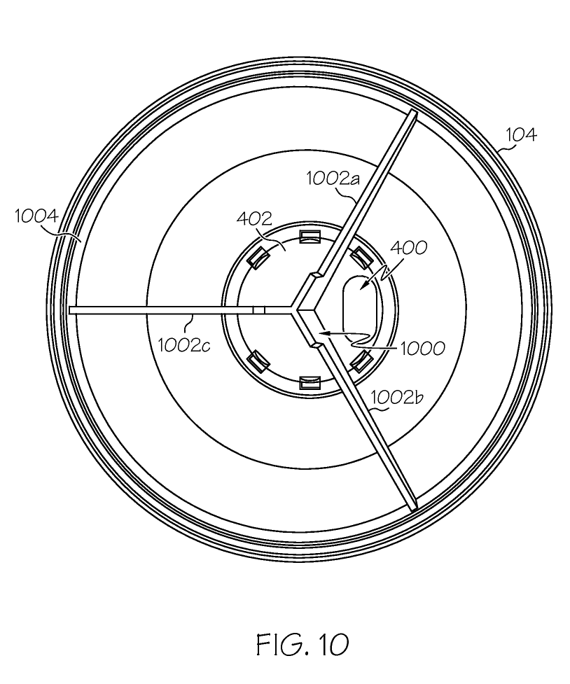

Referring now to FIG. 10, there is depicted a view of the interior of upper housing 104 of dispenser 100 of FIG. 1. As shown, upper housing 104, which is substantially hollow, contains an optional internal support 1000. In the illustrated embodiment, internal support 1000 is substantially aligned with central vertical axis 112 and extends, at its central point, between floor 402 of upper cavity 202 and base plate 604. In the illustrated embodiment, internal support 1000 includes three splines 1002a, 1002b and 1002c extending outwardly to contact and support inner surface 1004 of upper housing 104. In some embodiments, including that depicted in FIG. 10, splines 1002a, 1002b and 1002c do not extend downward all the way to base plate 604 in order to provide a lower cavity 602 of greater volume. As will be appreciated, internal support 1000 increases the rigidity of dispenser 100, making it less prone to breakage or deformation when in use.

In a typical animal use scenario, a human user removes cap 102 from upper housing 104 and optionally adjusts rotating plate 404 in upper cavity 202 to set the effective size of upper aperture 400 to a desired size that is preferably larger than at least one item to be dispensed. In general, the smaller the effective size of upper aperture 400, the more movement of dispenser 100 is required to cause items to progress from upper cavity 202 to lower cavity 602. The user also places one or more items to be dispensed in upper cavity 202 and/or cap 102 and then recouples cap 102 to upper housing 104. The user may also adjust a position of sliding door 110 in order to control the dispensing of items from lower cavity 602. Again, the smaller the opening of sliding door 110, the more manipulation of dispenser 100 is generally required to dispense items from lower cavity 602.

After dispenser 100 is loaded with one or more items to be dispensed, the human user may place loaded dispenser 100 on an underlying surface, such as a floor or the ground, and make the dispenser 100 accessible to an animal, such as a dog. As the animal interacts with dispenser 100 by pawing, pushing, rolling or otherwise moving dispenser 100 from its upright position, one or more items progress from upper cavity 202 to lower cavity 602 via upper aperture 400 and are eventually dispensed to an exterior of dispenser 100 via lower aperture 108. Following disturbance from its upright position, the dispenser 100 tends to self-right and to return to the upright position. In this manner, the animal is incentivized to interact with dispenser 100. It will be appreciated that the effective sizes of upper aperture 400 and lower aperture 108 can be adjusted at any time during use in order to make dispensing the item(s) easier or harder.

While the present invention has been particularly shown as described with reference to one or more preferred embodiments, it will be understood by those skilled in the art that various changes in form and detail may be made therein without departing from the spirit and scope of the invention. For example, those skilled in the art will appreciate that the outer contour of dispenser 100 can vary in various embodiments. With sufficient weight in the lower portion of the housing, the illustrated embodiment will self-right to the orientation shown in FIG. 1 from any position. In other embodiments, this need not be the case.

What is claimed is:

1. A dispenser, comprising:
a self-righting housing having:
an interior cavity for holding one or more items to be dispensed;
a curved bottom surface; and
a dispensing aperture, disposed in a lower portion of the housing and in communication with the interior cavity, through which the one or more items are dispensed.

2. The dispenser of claim 1, and further comprising:
an upper aperture disposed in an upper portion of the housing and in communication with the interior cavity.

3. The dispenser of claim 2, wherein:
the interior cavity is a lower cavity;
the housing further includes an upper cavity in communication with the lower cavity via the upper aperture; and
the dispenser further comprises a cap removably couplable to the housing, wherein the cap is removed from the housing to provide external access to the upper cavity.

4. The dispenser of claim 3, and further comprising an adjustment mechanism that selectively controls a size of the upper aperture.

5. The dispenser of claim 3, wherein the cap is removably couplable to the housing by one or more threads disposed on the cap or the housing.

6. The dispenser of claim 1, and further comprising an adjustment mechanism that selectively controls a size of the dispensing aperture.

7. The dispenser of claim 1, and further comprising a weight disposed in the lower portion of the housing.

8. The dispenser of claim 1, wherein the curved bottom surface is textured to provide skid-resistance.

9. The dispenser of claim 1, wherein the housing is generally tear-shaped.

10. A dispenser, comprising:
a self-righting housing having:
a lower interior cavity for holding one or more items to be dispensed;
an upper cavity in communication with the lower interior cavity via an upper aperture;
a curved bottom surface;
a dispensing aperture, disposed in a lower portion of the housing and in communication with the interior cavity, through which the one or more items are dispensed; and
a cap removably couplable to the housing, wherein the cap is removed from the housing to provide external access to the upper cavity.

11. The dispenser of claim 10, and further comprising an adjustment mechanism that selectively controls a size of the upper aperture.

12. The dispenser of claim 10, wherein the cap is removably couplable to the housing by one or more threads disposed on the cap or the housing.

13. The dispenser of claim 10, and further comprising an adjustment mechanism that selectively controls a size of the dispensing aperture.

14. The dispenser of claim 10, and further comprising a weight disposed in the lower portion of the housing.

15. The dispenser of claim 10, wherein the housing is generally tear-shaped.

16. A method of dispensing items from a dispenser including a self-righting housing having a curved bottom surface, said method comprising:
placing a plurality of items to be dispensed within the self-righting housing of the dispenser;
placing the curved bottom surface of the self-righting housing on an underlying surface;
disturbing the self-righting housing from an upright resting position, such that one or more of the plurality of items are dispensed from an interior cavity within the self-righting housing via a dispensing aperture disposed in a lower portion of the self-righting housing; and
following the disturbing, the self-righting housing returning toward the upright resting position.

17. The method of claim 16, wherein:
the dispenser includes an upper cavity in communication with the interior cavity via an upper aperture; and
the placing comprises placing the plurality of items in the upper cavity.

18. The method of claim 17, and further comprising enclosing the plurality of items in the upper cavity with a cap removably couplable to the housing, wherein the cap is removable from the housing to provide external access to the upper cavity.

19. The method of claim 18, wherein the enclosing comprises removably coupling the cap to the housing by one or more threads disposed on the cap or the housing.

20. The method of claim 17, and further comprising selectively controlling a size of the upper aperture with an adjustment mechanism.

21. The method of claim 16, and further comprising selectively controlling a size of the dispensing aperture with an adjustment mechanism.

22. A method of making a dispenser, said method comprising:
forming a self-righting housing having:
an interior cavity for holding one or more items to be dispensed;
a curved bottom surface; and
a dispensing aperture, disposed in a lower portion of the housing and in communication with the interior cavity, through which the one or more items are dispensed.

23. The method of claim 22, and further comprising:
forming in the housing an upper cavity in communication with the interior cavity via an upper aperture.

24. The method of claim 23, and further comprising forming an adjustment mechanism that selectively controls a size of the upper aperture.

25. The method of claim 23, and further comprising:
forming a cap removably couplable to the housing, wherein the cap is removed from the housing to provide external access to the upper cavity.

26. The method of claim 22, and further comprising forming an adjustment mechanism that selectively controls a size of the dispensing aperture.

27. The method of claim 22, and further comprising attaching a weight disposed in the lower portion of the housing.

28. The method of claim 22, and further comprising texturing the curved bottom surface to provide skid-resistance.

29. The method of claim 22, wherein forming the self-righting housing comprises forming a generally tear-shaped self-righting housing.

30. The method of claim 22, wherein forming the self-righting housing comprises:
forming an upper housing portion;
forming a separate lower housing portion; and
joining the upper housing portion and the lower housing portion.
